(19) United States
(12) Patent Application Publication
(10) Pub. No.: US 2016/0295108 A1
(43) Pub. Date: Oct. 6, 2016

(54) SYSTEM AND METHOD FOR PANORAMIC IMAGING

(71) Applicant: Cheng CAO, Tustin, CA (US)

(72) Inventor: Cheng CAO, Tustin, CA (US)

(21) Appl. No.: 14/676,706

(22) Filed: Apr. 1, 2015

(51) Int. Cl. H04N 5/232; H04N 5/265; H04N 5/247

(52) U.S. Cl. CPC H04N 5/23238; H04N 5/247; H04N 5/23229; H04N 5/265

(57) ABSTRACT

Provided herein are systems and methods for panoramic imaging. The present system includes multiple digital cameras having overlapping fields of view. The system further includes a control system that controls the geometry and action of the cameras to capture digital images or streams of image frames. The system further includes an image processing algorithm, the execution of which processes image inputs by the cameras into panoramic still images or movies in real time. The present method includes the steps of acquiring image information by multiple digital cameras having overlapping fields of view, analyzing each pair of image inputs having an overlapping field to identify an optimum line that makes the total error introduced by cutting and stitching the pair of image inputs along the line to be the minimum; and cutting and stitching the image inputs to generate panoramic images or movies.

### TECHNICAL FIELD

The present disclosure relates to the field of panoramic imaging systems, and more particularly to a system and related methods for generating high-definition (HD) panoramic photographs and videos. The present system and methods integrate image acquisition, image processing, instant and real-time panoramic presentation, mobile application, wireless data communication, Cloud computing, remote storage and other external services.

### BACKGROUND

Panoramic photography, the taking of a photograph or photographs covering an elongated field of view, has a long history in photography. Perhaps the most primitive method of panoramic photography is the taking of several adjoining photos with a conventional camera and then mounting the prints together in alignment to achieve a complete panorama. Modern techniques adapt this method by using digital cameras to capture the images, and then using computer image processing techniques to align the images for printing as a single panorama.

The continuous development of digital camera technologies along with constantly increasing speed and processing power of computers have laid the foundation for digital imaging systems that are capable of acquiring image data for the automatic creation of wide to entire 360° panoramas, including both still panoramic images and dynamic panoramic movies.

Currently, main-stream panoramic imaging solutions can be generally categorized into the multi-lens approach and the single-lens approach. Multi-lens panoramic cameras utilize a set of cameras for simultaneous image or video capturing. The cameras are typically arranged in either a parallel fashion as illustrated in FIG. 1A or a converged fashion as illustrated in FIG. 1B, such that each camera's field of view overlaps with that of at least one other camera. This way, the total field of view covered by the multi-camera systems is significantly enlarged as compared to a conventional single-lens camera.

However, due to physical constrains, current multi-camera systems cannot at all depth of field (DOF) levels stitch images captured by the set of cameras into one seamless panorama. Rather, the generated wide-field image always have disparities where the cameras' fields of view overlap. To illustrate this problem, take the dual-camera system shown in FIG. 2A as an example. As shown in the figure, the system has a pair of cameras arranged in parallel with respect to one another. Each camera has a field of view of a angle and the two fields of view overlap. O₁ and O₂ represent the optical centers of the two cameras, respectively. The distance between O₁ and O₂ is d. FIG. 2B shows a view point (c) within the overlapping field of view. According to the imaging principle, error due to parallax (error), depth of field (h) and distance between O1 and O2 (d) assume the relationship:

$$error \leq tan ( \frac{2 h}{d} ) .$$

Accordingly, parallax is directly related to the distance between the optical centers, and is inversely related to DOF. Further, because optical centers sit within the physical boundaries of the cameras, it is impossible to diminish the distance between O₁ and O₂ thereby eliminating parallax. This is why conventional multi-camera systems cannot produce seamless and continuous panoramas. To work around this problem, conventional systems often have to project the captured wide-field images on a panel of multiple displays, so that the defected areas can be covered up by the frames of the individual displays. Alternatively, some conventional systems choose to set up the cameras in a way such that the overlapping field of view would not be captured at the useful DOF. This approach, however, would cause missing fields of view between adjacent cameras, and thus also fails for the purpose of creating continuous and seamless panoramas.

Panoramic imaging solutions that do not invoke the use of multiple displays have also been proposed in the field. Single-lens panoramic cameras that utilize a wide- to ultra wide-angle lens for image acquisition are capable of achieving wide-angle views by forgoing producing imagery with straight lines of perspective (rectilinear images), opting instead for a special mapping which gives the imagery a characteristic convex non-rectilinear appearance. Typical wide-angle lenses used for this purpose include non-flat lenses and fisheye lenses. In this way, the imagery is captured by a single lens, thus the problem of disparity due to parallax and the accompanying need for image stitching do not exist. However, an apparent disadvantage of this type of cameras is that they produce strong visual distortions—the produced panoramas appear warped and do not correspond to a natural human view—which reduces authenticity and aesthetics of the imagery. Further, due to optical characteristics of wide-angle lenses, single-lens panoramic cameras typically require high environmental luminance for image acquisition, and even so, the delivered imagery is usually of low resolution and quality. This further limits applicability of this type of cameras.

To avoid the optical limitations of wide-angle lenses, single-lens panoramic cameras that use regular (narrow-angle) lenses have been proposed. Particularly, this type of cameras achieve a panorama's elongated field of view not by enlarging the view angle of the equipped lens, but rather through mechanical rotation of the lens across a wide pan of view to be captured. This solution is capable of generating high resolution and quality panoramas that are continuous and seamless at all DOF levels. However, this solution is only applicable to inanimate scenes, because if it is used to film animate objects, the delivered imagery will be deformed and fragmented.

An alternative panoramic imaging solution, sometimes known as the co-optical center panoramic technology, achieves the goal through the use of a combination of optical lenses and mirrors. Particularly, the mirrors may be mounted to a glass bevel such that the mirror surfaces form desirable angles with respect to one another. The set of optical lenses are positioned behind the glass bevel. According to the reflection principle, each optical lens takes a virtual image that has a virtual optical center. By designing the angle of the bevel and arranging the optical lenses to appropriate positions with respect to the bevel, the distance between the virtual optical centers of the multiple lenses can be brought very close to zero, thereby obtaining a set of nearly co-optical center images without disparities. In theory, the set of co-optical center images covers a wide-angle field of view and may be stitched at all DOF levels to produce continuous and seamless panoramas. However, in practice, images delivered by the set of lenses are still not seamlessly stitched due to defects and/or artifacts in processing of the mirrors and/or deviation in positioning of the lenses. Thus, subsequent image processing and correction by computer algorithms are still needed. A further disadvantage of co-optical center panoramic cameras also stems from the high complexity of the optical system. The complex combination of bevel mirrors and optical lenses is rather delicate and fragile, rendering the system less portable and also less affordable for daily use and entertainment by individual users.

Thus, there exists a need to provide a new panoramic imaging system with improved functionality and diversified applications at a significantly reduced price. Accordingly, an objective of the present disclosure is to provide a panoramic imaging system that is capable of delivering wide to entire 360° panoramas, including both still images and movies. The system according to the present disclosure is aimed to produce panoramic imagery that is continuous and seamless at all DOF levels and at the same time is also of high resolution, quality and visual reality. Further, the system of the present disclosure is suitable for using at all types of scenes, including both animated and inanimate ones.

Another objective of the present disclosure is to provide a panoramic imaging system that is capable of fast image processing to achieve instant and real-time panoramic presentation for an end user, as well as remote transmission, storage, and sharing of the generated panoramas.

Yet another objective of the present disclosure is to provide a panoramic imaging system that is built with a simplified optical system and a robust on-chip processing power, such that the system has agile functions and yet is portable and affordable for individual's daily uses, such as personal video recording, sport recording, driving recording, home monitoring, travel recording and other recreational uses, as well as large-scale business applications, such as telepresence, business exhibition and security surveillance, etc.

### SUMMARY OF THE INVENTION

Provided herein are panoramic imaging systems and methods. According one aspect of the present disclosure, methods for generating panoramic digital representation of an area is provided. Particularly, the method comprises acquiring an image from each of a plurality of digital cameras having a field of view that overlaps with the field of view of at least one other digital camera among the plurality of digital cameras; establishing spherical coordinates for pixels of each acquired image; rearranging the pixels of each acquired image in a plane according to the spherical coordinates, thereby generating a set of planar images having one or more overlapping fields. The method further comprises, in each overlapping field among the one or more overlapping fields, identifying pixels of interest and finding an optimum line that avoids the pixels of interest, thereby generating a set of optimum lines for the set of planar images. The method further comprises cutting and stitching the set of planar images along the set of optimum lines, thereby generating a panoramic digital representation of the area.

According to a second aspect of the present disclosure, a system for generating panoramic digital representation of an area is provided. Particularly, the system comprises a plurality of digital cameras having a field of view that overlaps with the field of view of at least one other camera among the plurality of digital cameras. The system further comprises a controller commanding each digital camera among the plurality of digital cameras to acquire an image. The system further comprises a processor executing an algorithm that establishes spherical coordinates for pixels of each acquired image and rearranges the pixels of each acquired image in a plane according to the spherical coordinates, thereby generating a set of planar images having one or more overlapping fields. In each overlapping field, the algorithm further identifies pixels of interest and finds an optimum line that avoids the pixels of interest, thereby generating a set of optimum lines for the set of planar images. The algorithm further cuts and stitches the set of planar images along the set of optimum lines, thereby generating a panoramic digital representation of the area.

In some embodiments of the present disclosure, the plurality of digital cameras assume a planar configuration or a folded configuration. Particularly, in the planar configuration, optical axes of all of the plurality of digital cameras fall in the same plane. Yet, in the folded configuration, optical axes of one or more digital cameras fall in a different plane. The two planes assume a folding angle, and the field of view of at least one digital camera having optical axis in one plane overlaps with the field of view of at least one digital camera having optical axis in the other plane.

The above aspects and objects of the present disclosure will become readily apparent upon further review of the following specification and drawings.

### BRIEF DESCRIPTION OF THE DRAWINGS

The accompanying drawings, which are incorporated into and constitute a part of this specification, illustrate one or more embodiments of the present disclosure and, together with the detailed description and examples, serve to explain the principles and implementations of the disclosure.

FIG. 1A is a schematic illustration of a set of cameras arranged in a converged fashion.

FIG. 1B is a schematic illustration of a set of cameras aligned in a parallel fashion.

FIG. 2A is a schematic illustration of a dual-camera system where two cameras are aligned in parallel with respect to one another. Each camera captures a field of view, and the two fields overlap horizontally. A distance between the optical centers of the two cameras (O₁ and O₂) is d.

FIG. 2B is a schematic illustration of error caused by parallax in a due-camera system with respect to a view point (c) in the cameras' overlapping field of view.

FIG. 3A is a perspective view of a four-camera system according to one embodiment of the present disclosure, showing a planar configuration of the system.

FIG. 3B is a schematic top view of a four-camera system according to one embodiment of the present disclosure, illustrating the horizontal field of view (α) of the cameras and the overlapping field of view (β) between neighboring cameras in the horizontal direction.

FIG. 4A is a perspective view of a four-camera system according to one embodiment of the present disclosure, showing a folded configuration of the system.

FIG. 4B is a schematic top view of a folded configuration of a four-camera system according to one embodiment of the present disclosure, illustrating the horizontal field of view (a) of the cameras and the overlapping field of view (β) between neighboring cameras in the horizontal direction.

FIG. 4C is a schematic side view of a folded configuration of a multi-camera system according to one embodiment of the present disclosure, illustrating the vertical field of view (γ) of the cameras, and the overlapping field of view (δ) in the vertical direction between a pair of neighboring cameras sitting in the two lines of cameras, respectively.

FIG. 5A is a schematic top view of a planar configuration of a eight-camera system according to one embodiment of the present disclosure, illustrating the horizontal field of view (α) of the cameras and the overlapping field of view (β) between neighboring cameras in the horizontal direction.

FIG. 5B is a schematic top view of a folded configuration of a eight-camera system according to one embodiment of the present disclosure, illustrating the horizontal field of view (α) of the cameras and the overlapping field of view (β) between neighboring cameras in the horizontal direction.

FIG. 6A is a perspective view of a folded configuration of a eight-camera system according to one embodiment of the present disclosure, illustrating the folded configuration in its horizontal placement.

FIG. 6B is a perspective view of a folded configuration of a eight-camera system according to one embodiment of the present disclosure, illustrating the folded configuration in its vertical placement.

FIG. 6C is a perspective view of a folded configuration of a four-camera system according to one embodiment of the present disclosure, illustrating spherical rotation and the field of view of the system in a three-dimensional space.

FIG. 7 is a block diagram of the panoramic imaging system according to the present disclosure.

FIG. 8A is a schematic illustration of spherical coordinate transformation of a pixel in a flat image by projecting the pixel onto a spherical surface tangential to the image plane.

FIG. 8B is an original digital image of a parking lot taken by a camera.

FIG. 8C is a digital image generated by the present algorithm after performing spherical coordinate transformation to the image of FIG. 8B, according to one embodiment of the present disclosure.

FIG. 9A illustrates two reasonable cutting and stitching lines in a situation where a close range object is completely included within an overlapping field of two adjacent images.

FIG. 9B illustrates a reasonable cutting and stitching line in a situation where close range objects are only partially included within an overlapping field of two adjacent images.

FIG. 10A shows a block of pixels in an image generated by stitching a pair of adjacent images (left and right images) together, illustrating the situation where the cutting positions are the same at adjacent rows of pixels.

FIG. 10B shows a block of pixels in an image generated by stitching a pair of adjacent images (left and right images) together, illustrating the situation where the cutting positions differ by one pixel at adjacent rows of pixels.

FIG. 10C shows a block of pixels in an image generated by stitching a pair of adjacent images (left and right images) together, illustrating the situation where the cutting positions differ by more than one pixels at adjacent rows of pixels.

FIG. 11 is a digital image of a parking lot generated by stitching two adjacent images together according to one embodiment of the present disclosure, illustrating a curved cutting and stitching line surrounding close range objects.

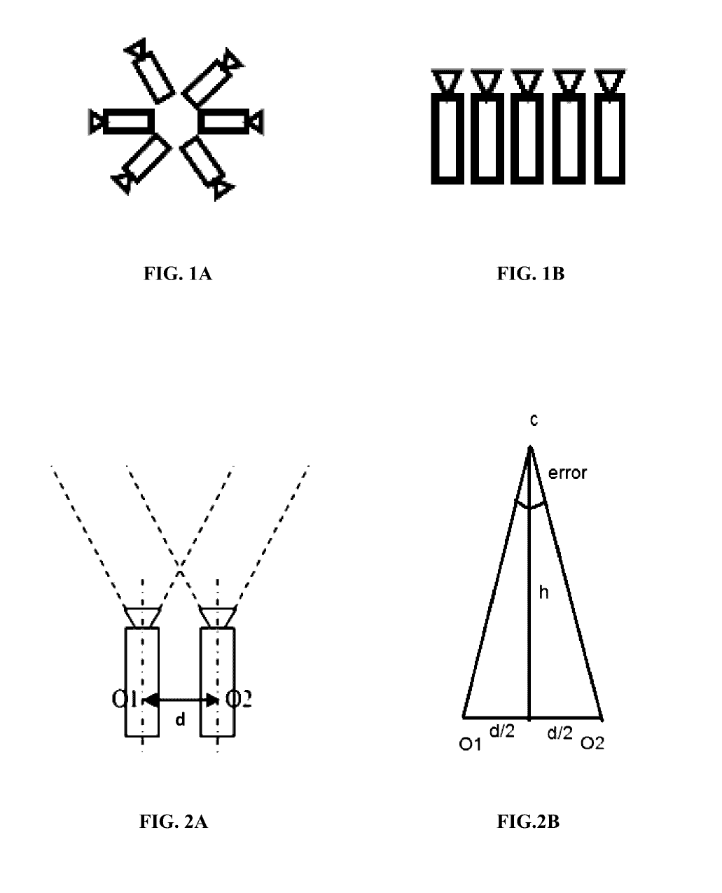

Similar reference characters denote corresponding features consistently throughout the drawings of the present disclosure.

### DETAILED DESCRIPTION

Provided herein are systems and methods for acquiring, creating and presenting panoramas, including still images and movies. According to one aspect of the present disclosure, a panoramic imaging system is provided. The panoramic imaging system according to the present disclosure includes at least an optical system, an image processing algorithm and a control system. Particularly, the optical system includes a set of cameras and is capable of capturing image information from a wide to ultra-wide field of view with high resolution, quality and visual reality. The image processing algorithm is capable of instantly processing image inputs by the set of cameras into continuous and seamless panoramas at all depth of field (DOF) levels for real-time presentation. Finally, the control system takes commands from an end user and controls the system to perform various functions.

Optical System

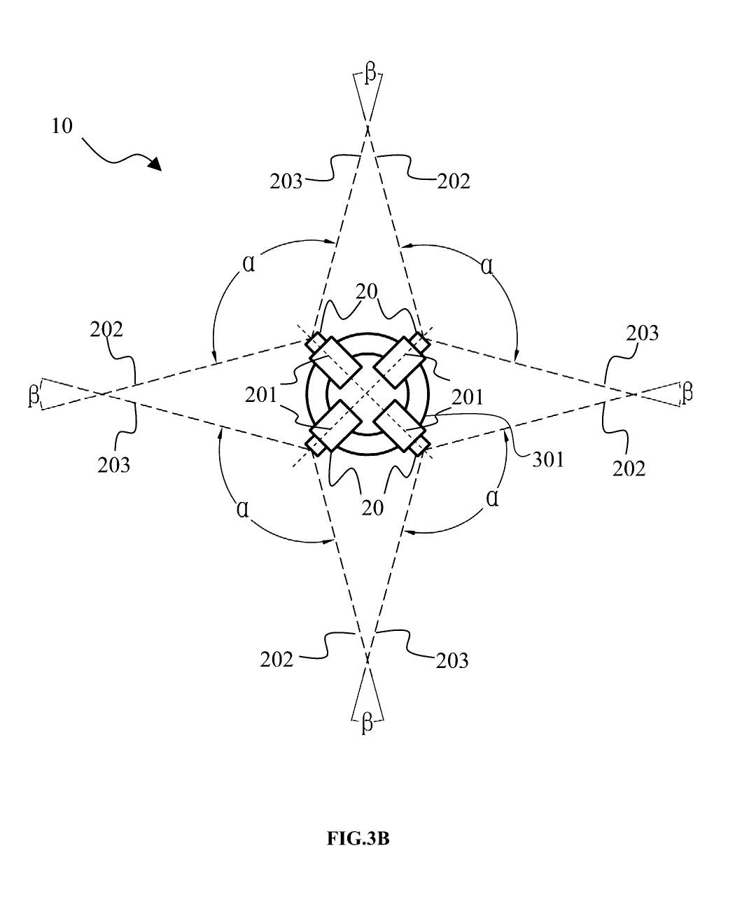

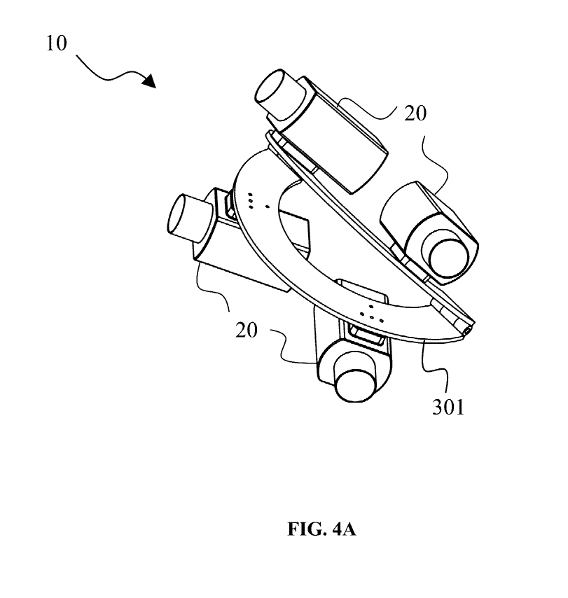

The optical system of the present disclosure is designed to acquire image information from a total of wide to 360° field of view. Particularly, the optical system is capable of acquiring image information from various different angles, and producing image inputs of high resolution, aesthetics and visual reality. Several exemplary embodiments of the present optical system are illustrated in FIGS. 3A through 6C and described in details below.

The optical system of the present disclosure is designated generally as element 10 in the drawings. The optical system (10) includes a set of digital cameras, designated generally as element 20 in the drawings, for capturing image information. The optical system (10) also includes mechanical parts for mounting, housing and/or moving the cameras (20) and other optical components.

According to some embodiments of the present disclosure, the optical system (10) has multiple digital cameras (20) mounted on a frame. The frame can assume a planer configuration and a folded configuration, of which the angle of folding may vary. In some embodiments, when the frame is in a planer configuration, optical axes of the cameras (20) mounted thereupon fall in the same plane and cross with each other at certain angles.

Referring to FIG. 3A, which shows a perspective view of an exemplary embodiment of the present disclosure. In this embodiment, the optical system (10) has four digital cameras (20) mounted on a circular frame (301) in a converged fashion. FIG. 3A shows the planar configuration of the system (10), where four cameras (20) are distributed evenly across a planer circle, each camera (20) facing a quadrant of a 360° field.

FIG. 3B is a top view of a planer configuration of the four-camera embodiment as shown in FIG. 3A. In this view, the frame (301) is placed horizontally, and an observer looks from above the frame (301) down at the plane of the frame (301) as well as the top of the four cameras (20). Dashed lines 201 represent the optical axes of the cameras (20). Dashed lines 202 and 203 represent the left and right boundary of the horizontal field of view of individual cameras (20), respectively. From this view, it can be appreciated that in the planer configuration, optical axes of all camera (20) fall on the same plane, and optical axes of a pair of adjacent cameras (20) cross at the angle of 90°.

Also shown in FIG. 3B, each camera (20) has a field of view lying between dashed lines 202 and 203; the angle of the field of view is designated as α. The fields of view of adjacent cameras (20) overlap; the overlapping angle is designated as β. Objects in an overlapping field of view is visible to both cameras (20), thus when the frame (301) is positioned horizontally, the optical system (10) has a total horizontal field of view of 360°.

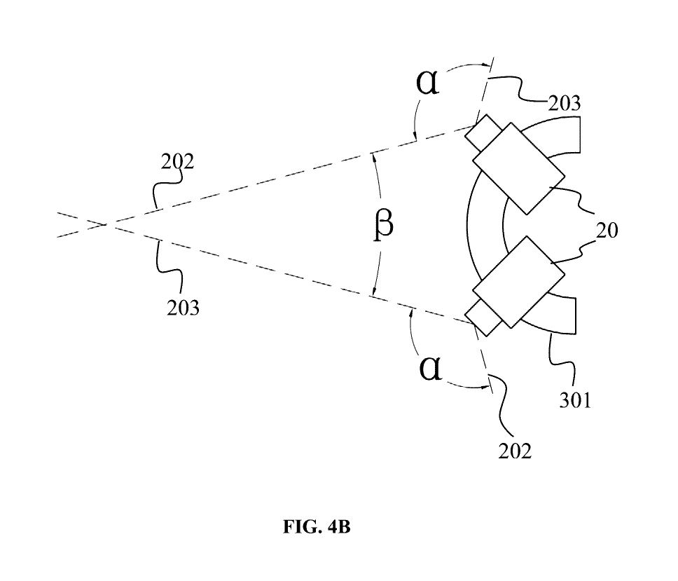

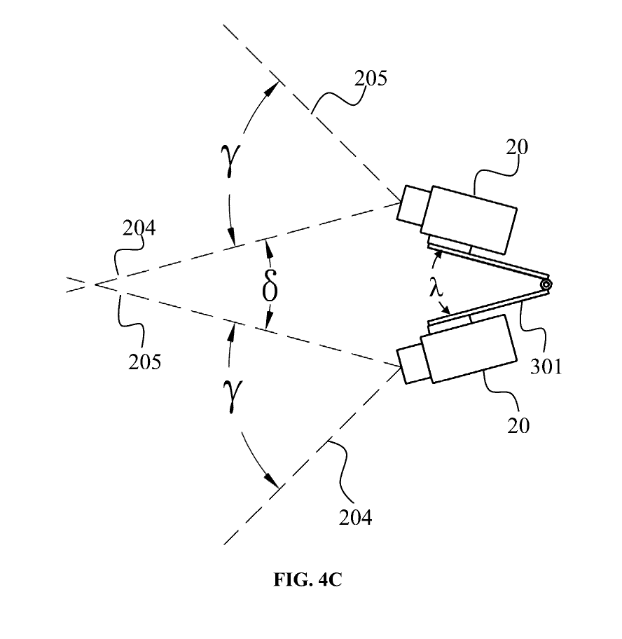

The exemplary embodiment of the optical system (10) illustrated in FIGS. 3A and 3B can further assume a folded configuration. A perspective view of the folded configuration is shown in FIG. 4A. Particularly, the frame (301) where the cameras (20) are mounted can be folded in half, such that the cameras (20) mounted on the two halves of the frame (301) are no longer in the same plane. Particularly, in the folded configuration, the two halves of the frame (301) assume an angle (2) with respect to one another (see FIG. 4C).

To illustrate, a group of cameras (20) mounted on the same half of a folded frame (301) is referred to as a line of cameras (20). Thus, a folded optical system (10) has two lines of cameras (20). Particularly, as shown in FIG. 4A, a folded four-camera embodiment has two cameras (20) in each line. As shown in FIG. 4B, the fields of view of the two cameras (20) in the same line overlap. Further as shown in FIG. 4C, the field of view of a camera (20) in a line overlaps with the field of view of another camera (20) in the other line.

FIG. 4B is a schematic top view of the exemplary four-camera embodiment in its folded configuration. Visible from this view are two cameras (20) in a same line. Also visible is the half of the folded frame (301) where the two cameras (20) are mounted. In a plane parallel to the visible half frame, each camera (20) assumes a field of view of α angle, and the two cameras' fields of view overlap for β angle.

FIG. 4C is a schematic side view of the folded configuration of a multi-camera optical system (10) according to the present disclosure. From this view, it can be appreciated that the folded optical system (10) has a top line and a bottom line of cameras (20). Visible from this view is one camera (20) from each line and the cross sections of both halves of the folded frame (301). In the vertical direction, each camera's field of view lies between dashed lines 204 and 205; the vertical view angle of a camera (20) is designated as γ. The field of view of a camera (20) in the top line overlaps with the field of view of a camera (20) in the bottom line, and the overlapping angle in the vertical direction is designated as δ.

It can be appreciated, at least from FIGS. 3B and 4C illustrating view angles of the present optical system (10) in horizontal and vertical directions respectively, that camera fields of view dictate the amount of overlap between adjacent cameras (20) and the size of blind spots of the system. Thus, selection of camera fields of view involves a tradeoff between maximizing coverage and image quality. Particularly, a larger camera field of view increases the amount of imaging information obtainable by a single camera as well as the amount of overlap between cameras. The larger overlap is, the smaller blind spots are and the more reliable the stitch processing is. Further, when the optical system (10) assumes the folded configuration, such as shown in of FIGS. 4B and 4C, a larger camera field of view (α, γ) could potentially increase the total field of view of the optical system (10) in horizontal and vertical directions, thereby increasing the dimension of a scene enclosed in a panorama. However, as camera fields of view increase, visual distortions increase and image resolutions decrease. Particularly, for larger fields of view, a flat panoramic representation cannot be maintained without excessively stretching pixels near the border of the image. In practice, flat panoramas start to look severely distorted once the camera field of view exceeds 90° or so. The reduction in resolution can be illustrated by considering a hypothetical digital camera with an output of 4,000 by 4,000 pixels and a field of view of 50°. Dividing 50° by 4,000 pixels gives the resolution of 1/80 of a degree per pixel. If the field of view is increased to 100°, the resolution is reduced a half to 1/40 of a degree per pixel. One approach to work around these problems is to equip the present system with the latest model of digital cameras, as the resolution increases while digital camera technologies advance. Particularly, digital camera resolution has followed Moore's law for semiconductors and has doubled about every year or two. This trend is expected to continue for at least the next fifteen years.

However, the approach of increasing camera resolution does not solve the problem of visual distortion and will also quadratically increase the computational burden for image processing. An alternative solution is to simply use more cameras (20) to cover a desirable total field of view, with each camera (20) covering a smaller field. Particularly, the present multi-camera optical system (10) can be equipped with any number of cameras (20). In some embodiments, the number of cameras (20) may range from 2 to 12. Particularly, in some embodiments, the present optical system (10) may be equipped with any even number of cameras (20), such as 2, 4, 6, 8, 10, or 12 cameras (20). In other embodiments, the optical system (10) may be equipped with any odd number of cameras (20), such as 3, 5, 7, 9, 10, or 11 cameras (20). For a converged set of cameras to cover a total 360° field of view, the number of cameras, the individual camera field of view and the angle of field overlap between adjacent cameras assume the following relationship:

$$β = \frac{( n \times α - 360 )}{n}$$

where n is the number of converged cameras in the system, α is the angle of individual camera field of view and β is the angle of overlapping field of view between adjacent cameras.

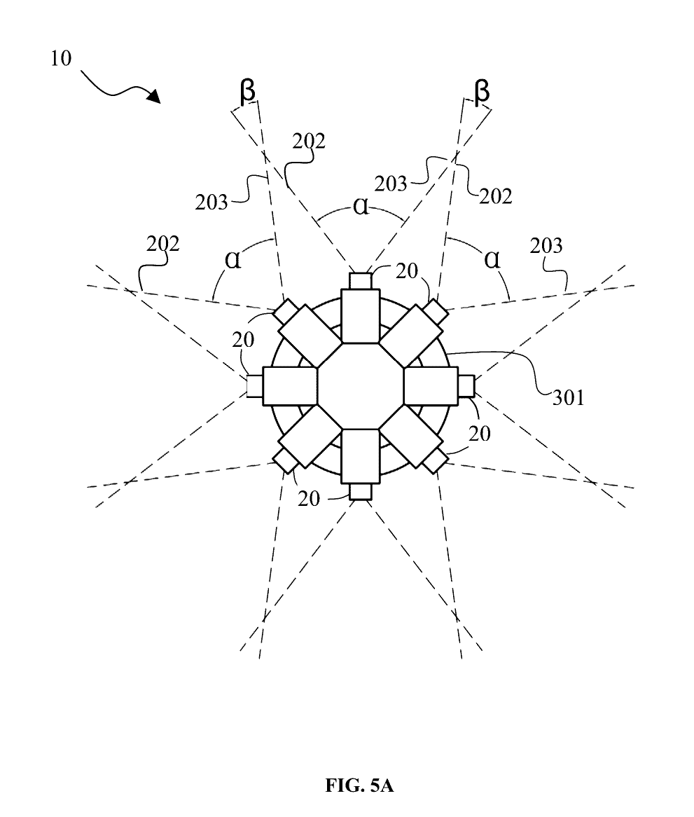

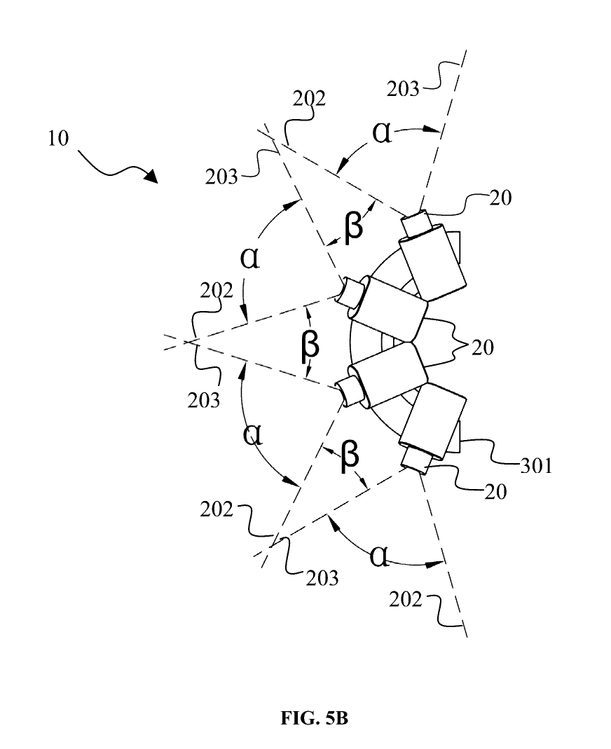

FIGS. 5A and 5B illustrate an exemplary eight-camera embodiment of the present optical system (10). Particularly, FIG. 5A shows a top view of the planar configuration of the optical system (10). Eight cameras (20) are mounted on a circular frame (301). The cameras (20) are distributed evenly across the circle, with the angle between adjacent cameras (20) being 45° and each camera facing a separate octant of a 360° field. In a plane parallel to the frame (301), the field of view of a camera (20) lies between dashed lines 202 and 203, assuming a angle and adjacent cameras' fields of view overlap for β angle. When the planar optical system (10) is placed horizontally, it has a total 360° horizontal field of view. FIG. 5B shows a top view of the folded configuration of the eight-camera embodiment. Visible from this view are four cameras (20) in a line and the half frame where the cameras (20) are mounted.

It can be appreciated from at least FIGS. 3B and 5A illustrating the horizontal view angle of the four-camera and eight-camera embodiments respectively, that a narrower horizontal field of view (α) may be adopted to achieve 360° horizontal coverage at particular DOF if the system (10) is equipped with more cameras (20). Particularly, for a four-camera embodiment of the present disclosure, α can range from 100° to 140°. More particularly, in some four-camera embodiments, a is 100°, 105°, 110°, 115°, 120°, 125°, 130°, 135° or 140°. In some four-camera embodiments, a is 120°, and accordingly β given by the above equation is 30°. For an eight-camera embodiment of the present disclosure, α can range from 70° to 100°. Particularly, in some eight-camera embodiments, α is 70°, 75°, 80°, 85°, 90°, 95°, or 100°. In some eight-camera embodiments, α is 70°, and accordingly β given by the above equation is 25°.

It can be further appreciated at least from FIG. 4C, illustrating the vertical view angle of a multi-camera optical system (10) in the folded configuration, that the total coverage in the vertical direction depends on the vertical field of view (γ) of individual cameras (20) as well as the folding angle of the frame (λ). Particularly, in the present system γ can range from 30° to 140°. More particularly, in some embodiments, γ is 30°, 40°, 50°, 60°, 70°, 80°, 90°, 100°, 110°, 120°, 130° or 140°. The folding angle (λ) of the frame (301) can range from 5° to 100°. Particularly, in some embodiments, λ is 5°, 10°, 15°, 20°, 25°, 30°, 35°, 40°, 45°, 50°, 55°, 60°, 65°, 70°, 75°, 80°, 85°, 90°, 95°, or 100°. Particularly, in some embodiments, γ is 120° and λ is 90°. In other embodiments, γ is 60° and λ is 30°. In some embodiments, the folding angle (λ) is predetermined and fixed by design. In other embodiments, the folding angle (λ) is adjustable, and can be changed by an end user according to specific needs.

The present disclosure further provides an image processing algorithm specifically adapted for the present optical system (10). The present algorithm is capable of fast processing image inputs by the set of cameras (20) into continuous and seamless panoramas at all DOF levels for real-time presentation. Particularly, the processing speed of the present algorithm achieves 30 frames per second (fps) with GPU (graphics processing unit) implementation, which is 3 to 6 folds faster than conventional image stitching algorithms that typically process at the speed of 5 to 10 fps for generating panoramas of comparable size and quality.

Briefly, the present image processing algorithm provides a simplified method for initial system calibration to correct manufacturing error and artifacts. Further, the present algorithm focuses on close range objects in a set of aligned images taken by cameras of overlapping fields of view to find optimal cutting and stitching lines (CASLs) surrounding these objects, thereby eliminating errors due to parallax in the overlapping field. These approaches significantly reduce the amount of calculation and shortened the time needed for blending the set of images into continuous and seamless panoramas. More detailed description of the present algorithm is provided further below.

It can now be appreciated that outputs of the present panoramic imaging system are panoramas stitched from a set of original images captured by the optical system (10). Thus, horizontal and vertical view angles of the outputs may vary, depending on the geometry that the optical system (10) adopts to acquire the original images. For example, if the optical system (10) adopts a planar configuration, the outputs can have a horizontal view ranging from narrow to 360°, and a vertical view angle ranging from a narrow to a wide or ultra-wide angle, such as 30° to 140° depending on the camera field of view (γ). Alternatively, if the optical system adopts a folded configuration, the outputs can have a horizontal view ranging from narrow to no less than 180°, and a vertical view of ranging from a narrow to an ultra-wide angle, depending on the camera field of view (γ) and the folding angle (λ).

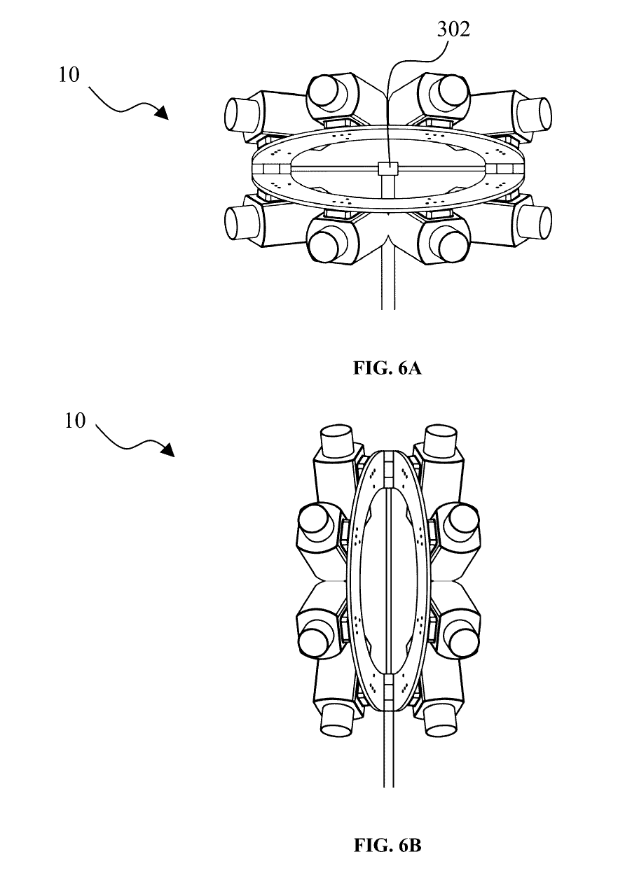

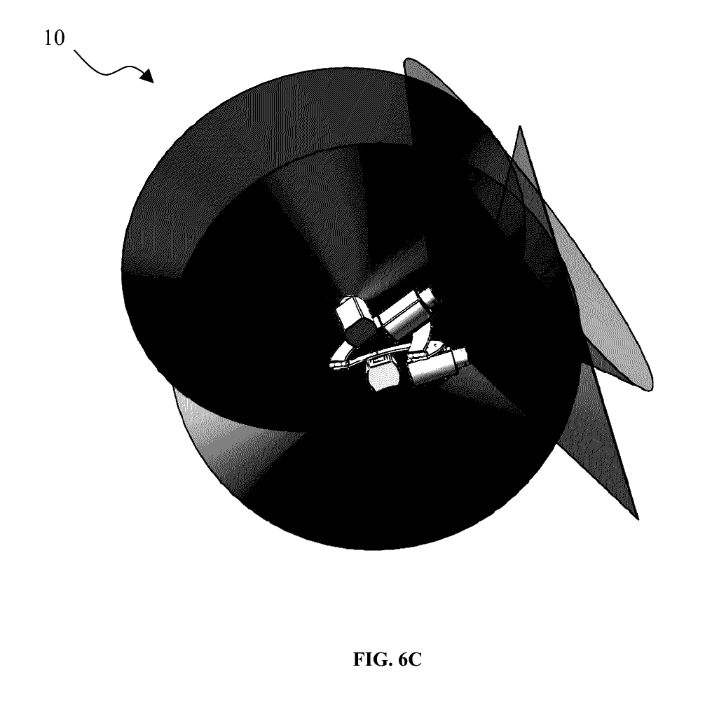

Additionally, the present panoramic imaging system can rotate and change the orientation of its optical system (10) in a three-dimensional (3D) space, thus capturing scenes from a variety of different angles. For example, FIGS. 6A and 6B are perspective views of a folded eight-camera embodiment, placed horizontally and vertically in a 3D space, respectively. Thus, horizontal and vertical dimensions of scenes captured by the two differential placements would be swapped. In some embodiments, the present optical system (10) is capable of spherical rotation in a 3D space. Particularly, in some embodiments, the spherical rotation is via a rotatable joint or hinge (302) placed at the center of the circular frame (301). FIG. 6C is a perspective view illustrating an exemplary embodiment of a four-camera optical system (10) rotated to a random angle in a 3D space and the corresponding fields of view of individual cameras (20). In some embodiments, movement and rotation of the optical system (10) is automatic and under the control of the control system according to an end user's command.

In some embodiments, the panoramic imaging system, including its optical system (10), control system and other auxiliaries, can be enclosed in a protective housing to reduce environmental effects on the components. In some embodiments, the protective housing is waterproof, dustproof, shockproof, freeze-proof, or any combination thereof. Further, in some embodiments, the optical system (10) can be reversibly coupled to or detached from the remaining system, such that an end user may select different models of an optical system (10) to be used with the imaging system according to particular needs or preferences.

It can be now appreciated that a variety of embodiments of the optical system (10) may be employed. These embodiments may have different numbers and/or arrangements of cameras (20), but a common feature is that each camera's field of view overlaps with that of at least one other camera (20), thereby enabling the system (10) to capture a total field of view according to the design. Those of ordinary skills in the art upon reading the present disclosure should become aware of how an optical system according to the present disclosure can be designed to satisfy particular needs. Particularly, skilled persons in the art would follow the guidance provided by the present disclosure to select a suitable number of cameras with reasonable fields of view and arrange the set of cameras such that neighboring cameras' fields of view have reasonable overlap that enables the system to cover a desirable total field and reliably process image information in the overlapping field to produce panoramas.

Control System

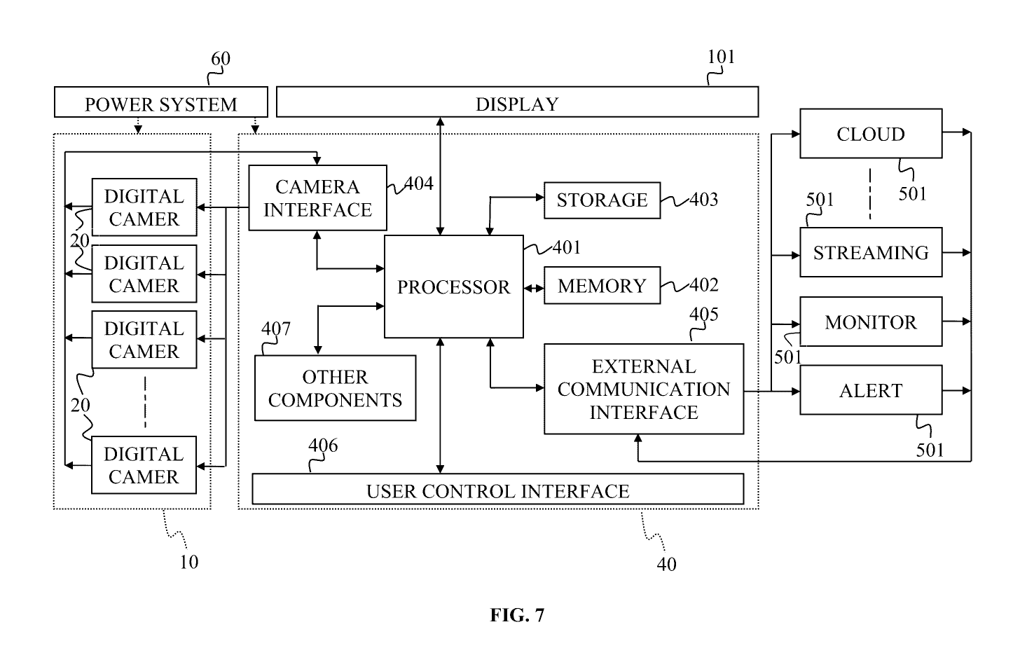

According to the present disclosure, the present panoramic imaging system includes a control system that controls the functions of the optical system (10) and the image processing algorithm. The control system is designated as element 40 in the drawings and is schematically illustrated in FIG. 7. Particularly, the control system (40) includes at least a processor (401), a memory (402), a storage device (403), a camera interface (404), an external communication interface (405), and a user control interface (406). The control system (40) can be a general-purpose computer system such as a Personal Computer (PC), or preferably a custom-designed computing system. Particularly in some embodiments, the control system (40) is a system on chip (SOC); that is, an integrated circuit (IC) integrates all components and functions of the control system (40) into a single chip, which makes the present panoramic imaging system portable and electronically durable as a mobile device. In some embodiments, the control system (40) may be located internally within a same housing where the optical system (10) is located. Alternatively, in other embodiments, the control system (40) is separated from the optical system (10) to allow end users' selection of different models of an optical system (10) to be used with the control system (40).

The storage device (403) is preloaded with at least the image processing algorithm of the present disclosure. Other customer-designed software programs may be preloaded during manufacture or downloaded by end users after they purchase the system. Exemplary customer-designed software programs to be used with the present panoramic imaging system include but are not limited to software that further processes panoramic images or videos according to an end user's needs, such as 3D modeling, object tracking, and virtual reality programs. Further exemplary customer-designed software includes but is not limited to image editing programs that allow users to adjust color, illumination, contrast or other effects in a panoramic image, or film editing programs that allow users to select favorite views from a panoramic video to make normal videos.

The electronic circuitry in the processor (401) carries out instructions of the various algorithms. Thus, the various software programs, stored on the storage device (403) and executed in the memory (402) by the processor (401), direct the control system (40) to act in concert with the optical system (10) to perform various functions, which include but are not limited to receiving commands from an end user or an external device or service (501), defining the precise geometry of the cameras (20), commanding the cameras (20) to capture raw image data, tagging and storing raw data in a local storage device (403) and/or commuting raw data to an external device or service (501), processing raw data to create panoramic images or videos according to commands received, presenting generated panoramas on a local display (101) and/or communicating generated panoramas to be stored or presented on an external device or service (501).

The processor (401) of the present disclosure can be any integrated circuit (IC) that is designed to execute instructions by performing arithmetic, logical, control and input/output (I/O) operations specified by algorithms. Particularly, the processor can be a central processing unit (CPU) and preferably a microprocessor that is contained on a single IC chip. In some embodiments, the control system (40) may employ a multi-core processor that has two or more CPUs or array processors that have multiple processors operating in parallel. In some embodiments, the processor (401) is an application specific integrated circuit (ASIC) that is designed for a particular use rather than for general purpose use. Particularly, in some embodiments, the processor (401) is a digital signal processor (DSP) designed for digital signal processing. More particularly, in some embodiments, the processor (401) is an on-chip image processor, specialized for image processing in a portable camera system. In some embodiments, the control system (40) includes a graphic processing unit (GPU), which has a massively parallel architecture consisting of thousands of smaller, more efficient cores designed for handling multiple tasks simultaneously. Particularly, in some embodiments, the control system (40) may implement GPU-accelerated computing, which offloads compute-intensive portions of an algorithm to the GPU while keeping the remainder of the algorithm to run on the CPU.

The memory (402) and the storage (403) of the present disclosure can be any type of primary or secondary memory device compatible with the industry standard, such as ROM, RAM, EEPROM, flash memory. In the embodiments where the control system (40) is a single chip system, the memory (402) and storage (403) blocks are also integrated on-chip with the processor (401) as well as other peripherals and interfaces. In some embodiments, the on-chip memory components may be extended by having one or more external solid-state storage media, such a secure digital (SD) memory card or a USB flash drive, reversibly connected to the imaging system.

The camera interface (404) of the present disclosure can be any form of command and data interface usable with a digital camera (20). Exemplary embodiments include USB, FireWire and any other interface for command and data transfer that may be commercially available. Additionally, it is preferred, although not required, that the optical system (10) be equipped with a single digital control line that would allow a single digital signal to command all the cameras (20) simultaneously to capture an image of a scene.

The external communication interface (405) of the present disclosure can be any data communication interface, and may employ a wired, fiber-optic, wireless, or another method for connection with an external device (501). Ethernet, wireless-Ethernet, Bluetooth, USB, FireWire, USART, SPI are exemplary industry standards. In some embodiments, where the control system (40) is a single chip system, the external communication interface (405) is integrated on-chip with the processor (401) as well as other peripherals and interfaces.

The user control interface (406) of the present disclosure can be any design or mode that allows effective control and operation of the panoramic imaging system from the user end, while the system feeds back information that aids the user's decision making process. Exemplary embodiments include but are not limited to graphical user interfaces that allow users to operate the system through direct manipulation of graphical icons and visual indicators on a control panel or a screen, touchscreens that accept users' input by touch of fingers or a stylus, voice interfaces which accept users' input as verbal commands and outputs via generating voice prompts, gestural control, or a combination of the aforementioned modes of interface.

The control system (40) of the present disclosure may further include other components that facilitate its function. For example, the control system (40) may optionally include a location and orientation sensor that could determine the location and orientation of the panoramic imaging system. Exemplary embodiments include a global positioning system (GPS) that can be used to record geographic positions where image data are taken, and a digital magnetic compass system that can determine the orientation of camera system in relation to the magnetic north. The control system (40) may optionally be equipped with a timing source, such as an oscillator or a phase-locked loop, which can be used to schedule automatic image capture, to time stamp image data, and to synchronize actions of multiple cameras to capture near simultaneous images in order to reduce error in image processing. The control system (40) may optionally be equipped with a light sensor for environmental light conditions, so that the control system (40) can automatically adjust hardware and/or software parameters of the system.

In some embodiments, the present panoramic imaging system is further equipped with an internal power system (60) such as a battery or solar panel that supplies the electrical power. In other embodiments, the panoramic imaging system is supported by an external power source. In some embodiments, the panoramic imaging system is further equipped with a display (101), such that panoramic photos may be presented to a user instantly after image capture, and panoramic videos may be displayed to a user in real time as the scenes are being filmed.

In some embodiments, the present panoramic imaging system may be used in conjunction with an external device for displaying and/or editing panoramas generated. Particularly, the external device can be any electronic device with a display and loaded with software or applications for displaying and editing panoramic images and videos created by the present system. In some embodiments, the external device can be smart phones, tablets, laptops or other devices programmed to receive, display, edit and/or transfer the panoramic images and videos. In some embodiments, the present panoramic imaging system may be used in conjunction with an external service, such as Cloud computing and storage, online video streaming and file sharing, or remote surveillance and alert for home and public security.

Image Processing Algorithm

According to a second aspect of the present disclosure, provided herein are also methods for processing captured image data into panoramic still pictures or movies at a fast speed. Particularly, the present disclosure provides a fast image processing algorithm that enables the present system to create and present panoramic images and videos to an end user instantly and in real time.

The present image processing algorithm registers set of images into alignment estimates, blends them in a seamless manner, and at the same time solves the potential problems such as blurring or ghosting caused by parallax and scene movements as well as varying image exposures. Particularly, the present algorithm provides a novel approach that finds the optimal cutting and stitching lines (CASL) among a set of images at a significantly improved speed. The processing speed of the present algorithm achieves 30 fps with GPU implementation, 3 to 6 folds faster than conventional algorithms which typically process at only 5 to 10 fps. Further, the present algorithm is capable of auto-adaptation to all types of scenes, including animated and unanimated, and can be used to create seamless and continuous panoramic still pictures and movies at all DOF levels. Several features of the present image processing algorithm are described below.

Spherical Coordinate Transformation

In the present optical system (10), precise geometry of the multi-camera assembly is known by design. That is, data defining the positions of each camera (20) are known to the image processing algorithm before processing starts. Thus, rough positions of a set of acquired images relative to one another on a final panoramic view are also known, which reduces calculation complexity for the algorithm.

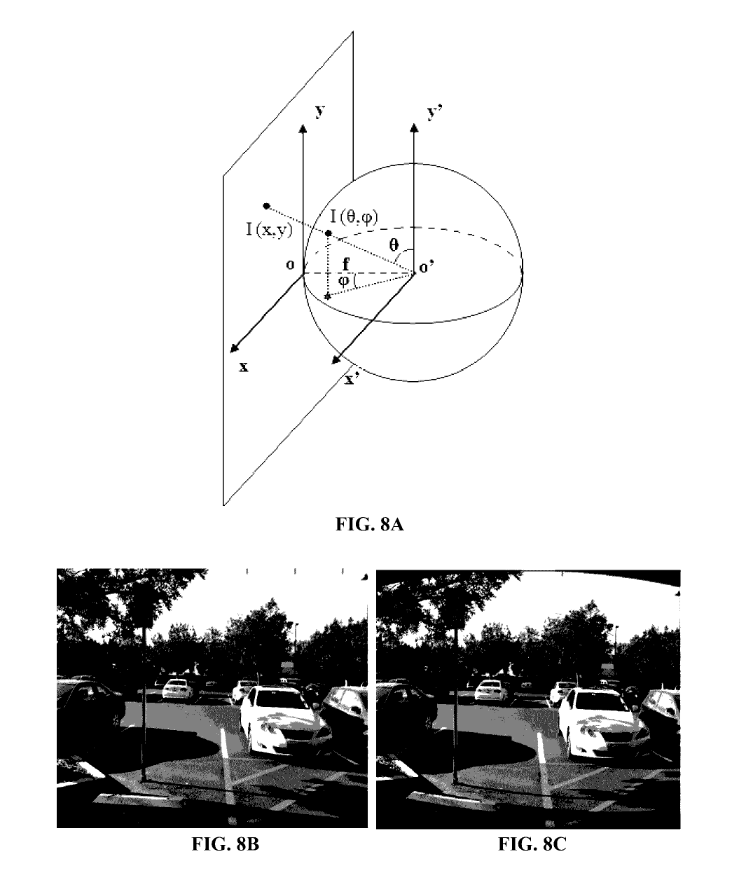

The present algorithm first performs spherical coordinate transformation for each image in an acquired set. In this step, the algorithm establishes spherical coordinates for each pixel in an original flat image. Particularly, each pixel I(x, y) is projected onto a spherical surface tangential to the original image plane. The projected pixel is then designated as I(θ, φ). As shown in FIG. 8A, the spherical surface has radius f and center o′; θ represents the angle between the positive y′-axis and a line connecting I(θ, φ) and o′; φ represents the coangle to the angle between the positive x′-axis and the line connecting I(θ, φ) and o′. Further, because the pixel is projected onto the spherical surface, a distance between I(θ, φ) and o′ is f. Accordingly, after spherical transformation of I(x, y) to I(θ, φ),

$$x = f \times tan ( ϕ )$$

$$y = \frac{f \times tan ( θ )}{cos ( ϕ )}$$

Thus, the algorithm takes 0 and φ as the two dimensions and generates a new two-dimensional (2D) image within the ranges of [−θ_{half}, θ_{half}], [−φ_{half}, φ_{half}], and specifically, θ_{half}=arctan(h/2f); φ_{half}=arctan (w/2f), where w and h are the width and height of the image, respectively. FIG. 8B is an original 2D image of a parking lot captured by a digital camera. FIG. 8C shows the new 2D image generated by the present algorithm after spherical coordinate transformation.

After spherical transformation, differences between pixel coordinates of images taken by adjacent cameras (20) can be expressed as horizontal translation (a), vertical translation (b), difference in the amount of 2D rotation surrounding the center of an image (c), or some kind of combination of a, b, and c. For a carefully manufactured digital camera, the optical components including the lens and image sensor assume a designed angle of rotation with respect to the camera's optical axis. Thus, the digital output of the camera, which is typically a rectangular image, also assumes a designed orientation in a 2D layout. In some embodiments of the present disclosure, the designed angles of rotation of all cameras (20) in the optical system (10) are the same. Thus, in these embodiments, the orientation of a set of acquired images on a 2D layout should also be the same, and any differential rotation (c) between adjacent images due to processing error or other artifacts is usually rather small. Accordingly, pixel coordinates in a pair of adjacent images I₀(θ, φ) and I₁(θ, φ) assume the approximate relationship I₀(θ, φ)=I₁(θ+(φ×c)+a, φ−(θ×c)+b), where a is the horizontal translation, b is the vertical translation, and c is the differential rotation.

Optional Calibration

The present system can be selectively calibrated before use to correct any deviation of the system's geometry from designed parameters, which deviation could be caused by errors, environmental effects, or artifacts during processing, manufacturing or customer use. Particularly, parameters to be calibrated may include the amount of horizontal translation (a), vertical translation (b), and differential rotation (c) between adjacent cameras (20), of which the fields of view overlap. To calibrate, the present algorithm performs pixel-based alignment to shift or warp a pair of images taken by adjacent cameras (20) relative to each other, and estimate translational or rotational alignment by checking how much the pixels agree. Particularly, the algorithm describes differences between the images using an error metrics, and then calculates the error metrics to find the optimal calibration parameters for the system.

Various methods known to skilled persons in the art may be employed to perform the pixel-based alignment. One exemplary way to establish an alignment between two images is to shift one image relative to the other. Given the template image I₀(x) sampled at discrete pixel locations {xi=(θi, φi)}, its location in the other image I₁(x) needs to be found. A least-squares solution to this problem is to find the minimum of the sum of squared differences (SSD) function:

$${E}_{SSD} ( u ) = {\sum }_{i}^{ } {[ {I}_{1} ( {x}_{i} + u ) - {I}_{0} ( {x}_{i} ) ]}^{2} = {\sum }_{i}^{ } {e}_{i}^{2}$$

where u=(u, v) is the displacement, and eᵢ=I₁(xᵢ+u)−I₀(xᵢ) is the residual error.

Other error metrics may also be employed to perform the pixel-based alignment, such as a correlation metrics, absolute differences metrics, robust error metrics or others that are known to skilled artisan in the art.

Once the error metrics has been established, a suitable search mechanism is devised for finding the optimum calibration parameters. A conventional search technique is to exhaustively try all possible alignments for each parameter of a, b, and c. That is, to conduct a full search in the discrete collections of parameters to be optimized: A={a₁, a₂, . . . aₙ.}, B={b₁, b₂, . . . bₙ.}, C={c₁, c₂, . . . cₙ.}; where n is the total number of pixels in one image. However, for this type of exhaustive search, the algorithm needs to check n³ pairs of parameters. The amount of calculation is usually huge, taking relatively long time to complete.

The present image processing algorithm adopts an alternative search mechanism that, by establishing a hierarchical order among discrete pixels to be searched, significantly reduces calculation complexity and accelerates the process. Particularly, in the present optical system (10), optical axes of all cameras (20) are designed to be in the same plane. This means the designed value of vertical translation (b) is zero. Also, all cameras (20) by design assume the same orientation with respect to their respective optical axes, which means the designed value of differential rotation (c) is also zero. By design, each camera (20) is to be mounted on the frame (301) to face a different direction, which means the designed value of horizontal translation (a) is greater than zero. This geometry determines that the designed vertical and rotational fixations of the cameras (20) are easier to achieve during manufacturing than the designed horizontal fixation, and the level of processing precision has a greater impact on the horizontal error than the vertical or rotational error. Accordingly, the system's horizontal error is usually greater than its vertical or rotational error.

Taking the above factors into consideration, the present image processing algorithm performs a three-step calibration, by searching according to the order of a, b, and c. Particularly, the algorithm first sets vertical translation (b) and differential rotation (c) to zero, and search pixel-by-pixel to find the optimal value of horizontal translation (a). Then, the algorithm adopts the optimal value of horizontal translation (a) found in the first step, continues to set differential rotation (c) to zero, and search pixel-by-pixel to find the optimal value of vertical translation (b). Finally, the algorithm adopts the optimal values of horizontal translation (a) and vertical translation (b) found in the prior steps, and search pixel-by-pixel to find the optimal value of differential rotation (c). Particularly, the optimal value of a, b, or c is the value that makes the error metrics' value minimal.

In some embodiments, the present algorithm further reduces the amount of calculation by reducing the number of pixels (n) to be searched in a pair of images. Particularly, in some embodiments, the algorithm only searches distant pixels for calibration. In these embodiments, the algorithm first takes a depth of field (DOF) threshold input, and searches only pixels having a DOF equal to or greater than the threshold in the images. In some embodiments, the DOF input is predetermined by design. In other embodiments, an end user may provide the input to the system by manually selecting a DOF for calibration.

Dynamic Image Stitching

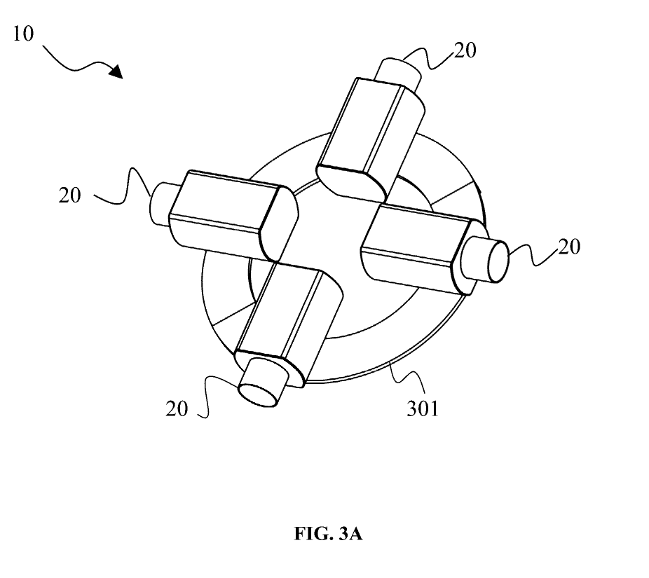

As shown in FIGS. 2A and 2B, for a pair of adjacent cameras that do not share the same optical center, parallax is inversely related to the depth of field (DOF). Thus, in a multi-camera imaging system, parallax in the distant range (larger DOF) is relatively smaller and sometimes negligible. On the contrary, parallax errors in the close range (smaller DOF) are usually obvious to a viewer, and thus need to be corrected by image processing. On the other hand, in a typical photograph or video frame, objects interesting to a viewer are usually in the close range, while irrelevant backgrounds is usually in the distant. Thus, the present algorithm is designed to recognize areas or objects of interest for a captured scene based on pixel DOF, and to eliminate parallax effects specifically for these areas or objects.

Particularly, the present algorithm achieves the goal of eliminating parallax by cutting and stitching images taken by adjacent cameras (20) along a cutting and stitching line (CASL) that surrounds close range areas or objects within the overlapping field of view of the cameras. Particularly, the algorithm recognizes objects (pixels) enclosed within the overlapping field of view by reading the geometry information of the optical system (10), the calibration parameters obtained from the most recent calibration, and the spherical coordinates of the pixels obtained from the spherical coordinates transformation step. Further, the algorithm takes a depth of field (DOF) threshold input, and identifies objects (pixels) in the close range of an image having DOF equal to or smaller than the threshold value. In some embodiments, the DOF threshold is predetermined by design. In other embodiments, an end user may provide the threshold input to the system by manually selecting a DOF for image stitching.

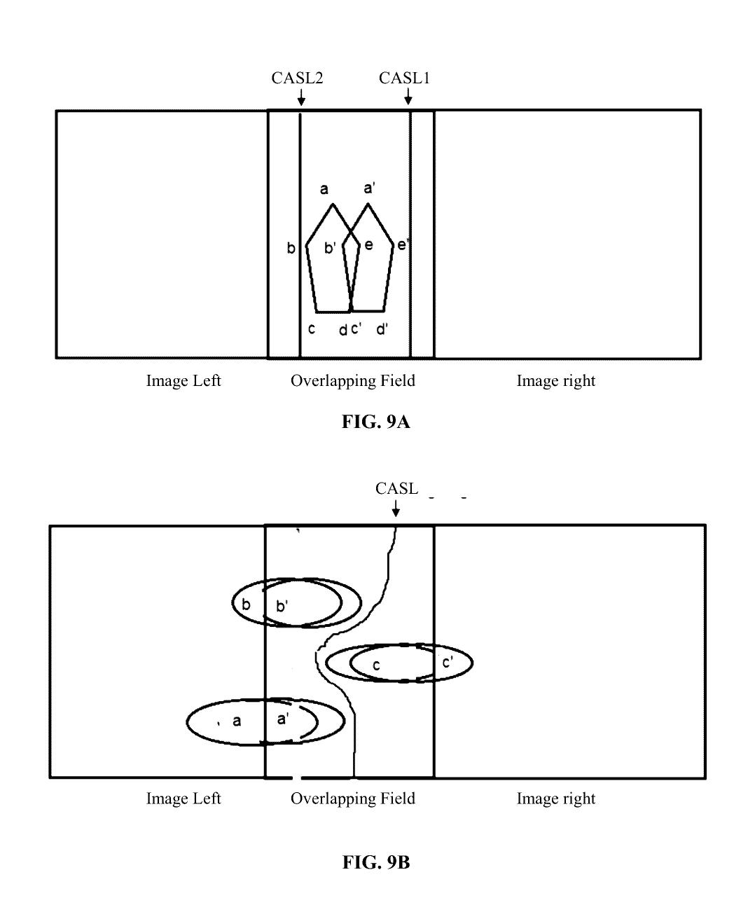

After the areas or objects of interest have been identified, the present algorithm then calculates a optimal CASL for the pair of images. FIG. 9A illustrates the situation where the algorithm recognizes one close range object completely enclosed within the overlapping field. This object of interest is marked “abcde” in the left image and as “a′b′c′d′e′” in the right image. In this situation, the pair of images can be cut and stitched via either CASL 1 or CASL 2, which are the two straight lines closely spanking the object of interest as shown in the figure. Particularly, if CASL1 is chosen, the portion of the left image containing the object (abcde) is included in the stitched image, while the portion of the right image containing the object (a′b′c′d′e′) is discarded. Alternatively, if CASL2 is chosen, the portion of the right image containing the object (a′b′c′d′e′) is included in the stitched image, while the portion of the left image containing the object (abcde) is discarded. Either way, in the stitched image, the object of interest comes from only one of the original images, thus no parallax effect would present for this close range area in the stitched image.

FIG. 9B illustrates the situation where the algorithm recognizes multiple close range objects within an overlapping field of view, namely the objects marked as a, b, and c in the left image, and correspondingly marked as a′, b′ and c′ in the right image. In this situation, none of the objects of interest is fully included within the overlapping field. In this situation, a reasonable CASL is a curved line surrounding each object of interest, as shown in the figure. After processing, the portion right to the CASL of the right image and the portion left to the CASL of the left image are stitched together along the line, and the remaining portions of the images are discarded. Again, all objects of interest included in the stitched image come from only one of the original images, thus no parallax effect would present for these close range areas in the stitched image.

To define the optimum CASL for a pair of images taken by adjacent cameras (20), the present algorithm finds an optimum cutting point for each row of pixels in the images, such that the value of

Σᵢ₌₀^{N}f(j(i))

reaches the minimum, where n is the number of rows of pixels in an image, and j(i) is the cutting point at row i. The optimum cutting points collectively across all rows of pixels define the optimum CASL. The optimum solution of the above equation can be found by dynamic programming as explained further below.

It can be appreciated that the present algorithm defines a novel cost function f(j(i)), that enables the algorithm to find an optimum CASL for stitching image inputs of adjacent cameras (20) into one continuous image. According to the present disclosure, the optimum CASL stably avoids close range objects in the overlapping field of view. Further, the present cost function assures that the optimum CASL is not overly curved, and thus does not cause horizontal shear effects in a stitched image.

Particularly, the cost function f(j(i)) calculates the total error introduced by cutting and stitching image inputs of adjacent cameras (20) into one continuous image; the total error represents the sum of differences between the two image inputs along the CASL and includes both horizontal error and vertical error.

Particularly, for each row (i) of pixels, a horizontal error is defined as the absolute difference between the pixel included in the stitched image, namely pixel I(i, j), and the pixel excluded from the stitched image, namely pixel (i, j′). Expressed in mathematical terms, the horizontal error at row i can be written as

error(i,j)=abs(I(i,j)−I′(i,j′))

where error (i, j) is the horizontal error at row i, I(i, j) is the pixel included in the stitched image, and I′(i, j′) the pixels excluded from the stitched image at the cutting point.

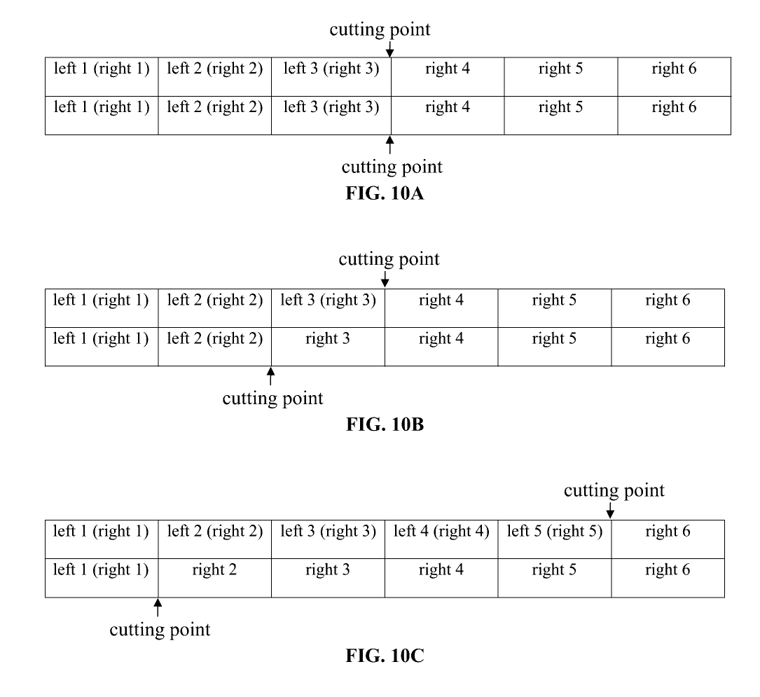

To further illustrate, FIG. 10A shows a block of pixels in a stitched image generated from a pair of adjacent images, namely the left and right images. Particularly, the block has two rows of pixels, each row having six pixels. FIG. 10A illustrates the situation where the cutting positions are the same at the adjacent rows, which is between the third and fourth pixels. Accordingly, for each row, three pixels on the left are pixels included from the left image, namely pixels “left 1,” “left 2,” and “left 3,” each replacing a pixel from the original right image, namely pixels “right 1,” “right 2,” and “right 3” shown in parenthesis. For each row, three pixels on the right are pixels included from the original right image, namely pixels “right 4,” “right 5,” and “right 6.” In this situation, only horizontal error is introduced, which is the sum of differences between included pixel “left 3” and replaced pixel “right 3” at each row.

Further, vertical error is introduced when the cutting positions at adjacent rows are different. To illustrate, consider row i and its adjacent row i−1. Vertical error is introduced when the cutting point j(i) of row i and the cutting point j(i−1) of row i−1 are different. To illustrate, FIG. 10B shows the situation where j(i) and j(i−1) differ only by 1 pixel. Particularly, cutting point j(i) is between the third and fourth pixels in the upper row, and cutting point j(i−1) is between the second and third pixels in the lower row. Similar to FIG. 10A, pixels in parentheses designate pixels from the right image that are replaced by left image pixels after cutting and stitching. In this situation, vertical error is the absolute difference between the one vertical pair of pixels flanked by the cutting points, namely the absolute difference between pixel “left 3” in the upper row and pixel “right 3” in the lower row.

In a more complicated situation where cutting positions at adjacent rows differ by multiple pixels, the vertical error is defined as the maximum or average absolute difference between vertical pairs of pixels flanked by the cutting points. To illustrate, FIG. 10C shows the situation where j(i) and j(i−1) differ by 4 pixels. Particularly, cutting point j(i) is between the fifth and sixth pixels in the upper row, and cutting point j(i−1) is between the first and second pixels in the lower row. Similar to FIGS. 10A and 10B, pixels in parentheses designate pixels from the right image that are replaced by left image pixels after cutting and stitching. In this situation, the present algorithm first calculates an absolute difference between each of the 4 vertical pairs of pixels flanked by the cutting points. That is, to calculate an absolute difference between each pair of upper “left 2” and lower “right 2”; upper “left 3” and lower “right 3”; upper “left 4” and lower “right 4”; upper “left 5” and lower “right 5.” Then the algorithm takes either the maximum value or the average value of the 4 calculated absolute difference values as the vertical error between rows i and i−1.

Expressed in mathematical terms, the vertical error can be either written as:

max(error(i,j(i):j(i−1)), if j(i−1)>j(i);

max(error(i,j(i−1):j(i)), if j(i−1)<j(i),

or alternatively written as

ave(error(i,j(i):j(i−1)), if j(i−1)>j(i);

ave(error(i,j(i−1):j(i)), if j(i−1)<j(i),

where j(i) and j(i−1) are the cutting points of adjacent rows i and i−1, respectively; and
error(i, j(i): j(i−1)) is the set of absolute differences between vertical pairs of pixels that are flanked by cutting points j(i) and j(i−1).

Therefore, the cost function f(j(i)) can be recursively defined as:

f(j(i))=error(i,j(i)), if j(i−1)=j(i);

f(j(i))=error(i,j(i))+max_or_ave(error(i,j(i):j(i−1)), if j(i−1)>j(i); or

f(j(i))=error(i,j(i))+max_or_ave(error(i,j(i−1):j(i)), if j(i−1)<j(i)

where j(i) and j(i−1) represents cutting points at adjacent rows i and i−1, respectively; error(i, j(i)) represents the horizontal error, max_or_ave(error(i, j(i):j(i−1)) or max_or_ave(error(i, j(i−1):j(i)) represents vertical error.

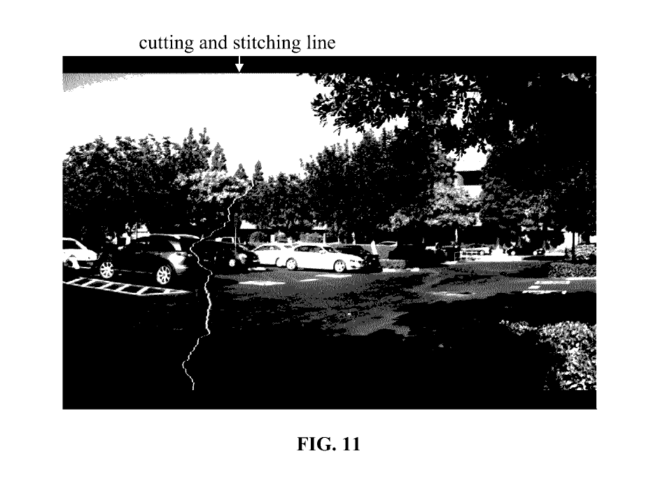

The present algorithm thus finds an optimum CASL that makes Σᵢ₌₀^{N}f(j(i)) reach the minimum, which is found when the total error introduced by cutting and stitching a pair of images along the CASL is the smallest. FIG. 11 shows a digital image of a parking lot generated by the present algorithm after stitching a pair of image inputs by adjacent cameras (20) together. A curved CASL is marked in white in the figure. As can be seen from the figure, the CASL avoids close range objects, such as the top of the tree, and results in near seamless stitching. For a multi-camera imaging system, the present algorithm is capable of calculating an optimum CASL for each overlapping field among a set of image inputs, thereby achieving seamless stitching of any number of images acquired by the set of cameras (20) into one image.

Smoothing Seam Boundary

Sometimes, image inputs of adjacent cameras (20) are taken with different exposures or under different illumination conditions. In this situation, a seam along the CASL of a stitched image may be visible, separating a darker portion and a brighter portion of the image. Accordingly, in some embodiments of the present disclosure, after cutting and stitching, the algorithm further processes the image to compensate for exposure or illumination differences, thereby blending in any visible seams or other minor misalignments. Various methods and algorithms for smoothing the seam boundary may be employed, including those known to the skilled artisan in the art. For example, in some embodiments, the present algorithm uses the gradient domain blending method, which instead of copying pixels copies the gradients of the new image fragment. The actual pixel values for the copied image are then computed by solving an equation that locally matches the gradients while obeying the fixed exact matching conditions at the seam boundary. Other methods for smoothing the seam boundary known to skilled persons in the art may be used.

Movie Processing

In some embodiments, the present image processing algorithm is capable of creating panoramic movies. Particularly, to make a panoramic movie, the set of cameras (20) are synchronized to each acquire a stream of image frames. A set of frames taken by the group of cameras (20) at the same time is then processed and stitched into one panoramic frame by the present algorithm. This way, the algorithm creates a panoramic video frame by frame. In some embodiments, the present algorithm further uses a threshold renewal method to reduce image jitter due to the use of different CASLs for continuous video frames, thereby improving stability for a fluid dynamics video.

To illustrate, the panoramic frame currently under algorithm processing is called the current frame. The first panoramic frame is generated according to the method described in above section of Dynamic Image Stitching. Starting from the second panoramic frame, the present algorithm calculates a threshold error for each current frame, based on the CASL used for generating the panoramic frame immediately before it. Particularly, the threshold error is the total horizontal error as defined in above section Dynamic Image Stitching along the last used CASL. Expressed in mathematical terms, the threshold error can be written as

$$error\_threshold \_current = {\sum }_{i = 0}^{n} error ( i , i ( j ) )$$

where i is the pixel row, n is the number of pixel rows in an image, error (i, i(j)) represents the horizontal error along the last used CASL.

Then the algorithm calculates the optimum CASL for the current frame according to the method described in above section Dynamic Image Stitching. Next, the algorithm compares the total horizontal error along the optimum CASL to the threshold error along the last used CASL, and determines which CASL should be used for processing the current frame. Particularly, only if the horizontal error along the optimum CASL is significantly smaller than the threshold error, the algorithm will adopt the optimum CASL for processing the current frame. Otherwise, the algorithm continues to use the last used CASL for processing the current frame. Particularly, the level significance ranges from 5 to 50%. In some embodiments, the algorithm adopts the optimum CASL for the current frame only if the horizontal error is smaller than the threshold error by 5%, 10%, 15%, 20%, 25%, 30%, 35%, 40%, 45% or 50%. This approach thus minimizes the difference among sequential panoramic frames to increase stability of the video.

The exemplary embodiments set forth above are provided to give those of ordinary skill in the art a complete disclosure and description of how to make and use the embodiments of the devices, systems and methods of the disclosure, and are not intended to limit the scope of what the inventors regard as their disclosure. Modifications of the above-described modes for carrying out the disclosure that are obvious to persons of skill in the art are intended to be within the scope of the following claims. All patents and publications mentioned in the disclosure are indicative of the levels of skill of those skilled in the art to which the disclosure pertains. All references cited in this disclosure are incorporated by reference to the same extent as if each reference had been incorporated by reference in its entirety individually.

The entire disclosure of each document cited (including patents, patent applications, journal articles, abstracts, laboratory manuals, books, or other disclosures) is hereby incorporated herein by reference.

It is to be understood that the disclosures are not limited to particular compositions or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A method for generating panoramic digital representation of an area, comprising
(1) acquiring an image from each of a plurality of digital cameras having a field of view that overlaps with the field of view of at least one other digital camera among the plurality of digital cameras;
(2) establishing spherical coordinates for pixels of each acquired image,
(3) rearranging the pixels of each acquired image in a plane according to the spherical coordinates, thereby generating a set of planar images having one or more overlapping fields,
(4) in each overlapping field among the one or more overlapping fields, identifying pixels of interest and finding an optimum line that avoids the pixels of interest, thereby generating a set of optimum lines for the set of planar images,
(5) cutting and stitching the set of planar images along the set of optimum lines, thereby generating a panoramic digital representation of the area.

2. The method of claim 1, wherein step (2) is performed by
establishing a spherical coordinate system for each acquired image in a sphere tangential to the acquired image, and
projecting the pixels of each acquired image onto surface of the sphere thereby obtaining the spherical coordinates of the pixels.

3. The method of claim 1, wherein the one or more overlapping fields in the set of planar images are predetermined based on positional parameters and the field of view of the plurality of digital cameras.

4. The method of claim 1, wherein in step (4) identifying the pixels of interest in one overlapping field among the one or more overlapping fields is performed by identifying pixels in the overlapping field having depth of view lower than a predetermined threshold.

5. The method of claim 1, wherein in step (4) finding the optimum line in one overlapping field among the one or more overlapping fields is performed by
analyzing a pair of planar images among the set of planar images, the pair of planar images sharing the overlapping field, wherein an optimum cutting point is determined for each row of pixels within the overlapping field, thereby obtaining a set of optimum cutting points, the set of optimum cutting points defining the optimum line.

6. The method of claim 5, wherein the optimum cutting point is determined such that a total difference between the pair of planar images along the optimum line is minimum.

7. The method of claim 6, wherein the total difference comprises a horizontal difference and a vertical difference;
wherein the horizontal difference is a first sum of differences between pixels of the pair of planar images at the optimum cutting point of each row of pixels; and
wherein the vertical difference is a second sum of differences between pixels of the pair of planar images at adjacent rows of pixels, when the optimum cutting points are different at the adjacent rows of pixels.

8. The method of claim 1 further comprising calibrating positional parameters of the plurality of digital cameras, the positional parameters comprising horizontal transformation (a), vertical transformation (b) and differential rotation (c) among the plurality of digital cameras; wherein the calibrating is performed by
establishing an error metrics for pixel-based alignment of a pair of planar images among the set of planar images,
searching pixel-by-pixel to find a first optimum solution for the error metrics while setting b and c to zero, thereby obtaining a calibrated a;
searching pixel-by-pixel to find a second optimum solution for the error metrics while adopting the calibrated a and setting c to zero, thereby obtaining a calibrated b;
searching pixel-by-pixel to find a third optimum solution for the error metrics while adopting the calibrated b and c, thereby obtaining a calibrated c.

9. The method of claim 1, further comprising smoothing a boundary of cutting and stitching the set of planar images along the set of optimum lines.

10. The method of claim 1, further comprising repeating steps (1) through (5) multiple times, thereby generating a sequential series of panoramic digital representations of the area.

11. A system for generating panoramic digital representation of an area, comprising
a plurality of digital cameras having a field of view that overlaps with the field of view of at least one other camera among the plurality of digital cameras,
a controller commanding each digital camera among the plurality of digital cameras to acquire an image,
a processor executing an algorithm that establishes spherical coordinates for pixels of each acquired image and rearranges the pixels of each acquired image in a plane according to the spherical coordinates, thereby generating a set of planar images having one or more overlapping fields, wherein
in each overlapping field among the one or more overlapping fields, the algorithm further identifies pixels of interest and finds an optimum line that avoids the pixels of interest, thereby generating a set of optimum lines for the set of planar images, and wherein
the algorithm further cuts and stitches the set of planar images along the set of optimum lines, thereby generating a panoramic digital representation of the area.

12. The system of claim 11, wherein the system establishes spherical coordinates for pixels of each acquired image by:
establishing a spherical coordinate system for each acquired image in a sphere tangential to the acquired image, and
projecting the pixels of each acquired image onto surface of the sphere thereby obtaining the spherical coordinates of the pixels.

13. The system of claim 11, wherein the system determines the one or more overlapping fields in the set of planar images based on positional parameters and the field of view of the plurality of digital cameras.

14. The system of claim 11, wherein the system identifies the pixels of interest in one overlapping field among the one or more overlapping fields by identifying pixels in the overlapping field having depth of view lower than a predetermined threshold.

15. The system of claim 11, wherein the system finds the optimum line in one overlapping field among the one or more overlapping fields by
analyzing a pair of planar images among the set of planar images, the pair of planar images sharing the overlapping field, wherein an optimum cutting point is determined for each row of pixels within the overlapping field, thereby obtaining a set of optimum cutting points, the set of optimum cutting points defining the optimum line.

16. The system of claim 15, wherein the optimum cutting point is determined such that a total difference between the pair of planar images along the optimum line is minimum.

17. The system of claim 16, wherein the total difference comprises a horizontal difference and a vertical difference;
wherein the horizontal difference is a first sum of differences between pixels of the pair of planar images at the optimum cutting point of each row of pixels; and
wherein the vertical difference is a second sum of differences between pixels of the pair of planar images at adjacent rows of pixels, when the optimum cutting points are different at the adjacent rows of pixels.

18. The system of claim 11,
wherein the plurality of digital cameras assume a planar configuration or a folded configuration;
wherein in the planar configuration, optical axes of the plurality of digital cameras fall in a first plane, and in the folded configuration, optical axes of one or more digital cameras among the plurality of digital cameras fall in a second plane;
wherein the first plane and the second plane assume a folding angle; and
wherein the field of view of at least one digital camera having optical axis in the first plane overlaps with the field of view of at least one digital camera having optical axis in the second plane.

19. The system of claim 18, wherein the planar configuration or folded configuration of the plurality of digital cameras is capable of spherical rotation in a three-dimensional space.

20. The system of claim 18, wherein the system is capable of calibrating positional parameters of the plurality of digital cameras.
